(19) United States
(12) Patent Application Publication
(10) Pub. No.: US 2022/0083052 A1
(43) Pub. Date: Mar. 17, 2022

(54) VEHICLE CONTROL SYSTEM AND VEHICLE

(71) Applicant: TOYOTA JIDOSHA KABUSHIKI KAISHA, Toyota-shi (JP)

(72) Inventor: Keisuke OYAMA, Nisshin-shi (JP)

(73) Assignee: TOYOTA JIDOSHA KABUSHIKI KAISHA, Toyota-shi (JP)

(21) Appl. No.: 17/470,149

(22) Filed: Sep. 9, 2021

(30) Foreign Application Priority Data
Sep. 15, 2020 (JP) 2020-154284

(51) Int. Cl. G05D 1/00; B60W 60/00; H04W 4/40; H04W 12/069

(52) U.S. Cl. CPC G05D 1/0022; G05D 1/0016; B60W 60/00; G05D 2201/0213; H04W 12/069; B60W 2540/043; B60W 2556/45; H04W 4/40

(57) ABSTRACT

A vehicle control system comprises a portable terminal and a vehicle including a communication device configured to establish a wireless communication connection with the portable terminal to be enabled to wirelessly communicate with the portable terminal when the communication device is in an activated state, and to be disabled to wirelessly communicate with the portable terminal when the communication device is in an inactivated state. The vehicle automatically travels to a predetermined target position in accordance with an instruction received by the communication device through the wireless communication with the portable terminal. The vehicle monitors, when the communication device is in the inactivated state, whether an activation condition is satisfied, the activation condition being satisfied when a user holding legitimate qualification for driving the vehicle exists within a predetermined communication possible range, and changes a state of the communication device to the activated state when the activation condition is satisfied.

### TECHNICAL FIELDS

The present disclosure relates to a vehicle control system, which includes a vehicle and a portable terminal configured to communicate with the vehicle, and is configured to cause the vehicle to automatically travel to a target position in accordance with an operation on the portable terminal by a user existing outside the vehicle, and to a vehicle, which is configured to automatically travel to a target position in accordance with an operation on a portable terminal by a user existing outside the vehicle.

### BACKGROUND

Hitherto, there has been known a vehicle control system configured to allow a user existing outside a vehicle to operate a portable terminal (for example, a smartphone or a portable tablet terminal) to cause the vehicle to automatically travel to a target position.

The control of the vehicle through use of the portable terminal is also referred to as “remote operation control” for the sake of convenience. For example, the vehicle control system described in Japanese Patent Application Laid-open No. 2016-97927 (hereinafter referred to as “related-art system”) allows execution of the remote operation control when matching of both of an electronic key of a vehicle and a portable terminal are successful.

### SUMMARY

The vehicle includes a communication unit (a communication device) for communicating with the portable terminal. The communication unit is configured to be enabled to communicate with the portable terminal when the communication unit is in an activated state, and to be disabled to communicate with the portable terminal when the communication unit is in an inactivated state. When an ignition switch of the vehicle is off, it is desired that the communication unit be in the inactivated state so that the communication unit does not wastefully consume electric power. However, when the communication unit is in the inactivated state while the ignition switch is off, it is required for the user to execute a certain operation in order to change the state of the communication unit to the activated state before the user executes an operation relating to the remote operation control on the portable terminal.

The related-art system does not consider a timing for changing the state of the communication unit from the inactivated state to the activated state. In a case in which the timing for the change is too late, even when the user operates the portable terminal, the vehicle cannot detect the operation, and thus the user may feel a sense of discomfort. Meanwhile, when the timing for the change is too early, the communication unit wastefully consumes the electric power.

The present disclosure has been made in view of the above-mentioned problem. That is, one object of the present disclosure is to provide a vehicle control system capable of changing a state of a communication unit from an inactivated state to an activated state at an appropriate timing when remote operation control is to be executed.

A vehicle control system (hereinafter referred to as “system of the present disclosure”), according to at least one embodiment of the present disclosure comprises:

a portable terminal (27) configured to execute wireless communication; and

a vehicle (VA) which includes a communication device (25) configured to establish a wireless communication connection with the portable terminal to be enabled to wirelessly communicate with the portable terminal when the communication device is in an activated state, and to be disabled to wirelessly communicate with the portable terminal when the communication device is in an inactivated state, the vehicle being configured to automatically travel to a predetermined target position in accordance with an instruction received by the communication device through the wireless communication with the portable terminal.

The portable terminal is configured to transmit the instruction when a predetermined operation is executed by a user (Step 332).

The vehicle is configured to monitor, when the communication device is in the inactivated state, whether an activation condition is satisfied, the activation condition being satisfied when a user holding legitimate qualification for driving the vehicle exists within a predetermined communication possible range, which is outside the vehicle, and in which a distance from the vehicle is shorter than a predetermined distance (Step 205, Step 210, Step 304, Step 306, Step 505 to Step 515), and to change a state of the communication device from the inactivated state to the activated state when the activation condition is satisfied (Step 215, Step 308, Step 525).

With the system according to the present disclosure, when the activation condition, which is satisfied when the user (legitimate user) holding the legitimate qualification for driving the vehicle exists within the communication possible range, is satisfied, the state of the communication device is changed to the activated state. When the user is to operate the portable terminal to start the control (remote operation control) of causing the vehicle to travel to the target position, the user approaches the vehicle so that the user exists within the predetermined distance from the vehicle, and then operates the portable terminal. With the system according to the present disclosure, in this case, the activation condition is satisfied without requiring the operation by the user, and the state of the communication device is changed to the activated state. When the communication between the vehicle and the portable terminal is required, the communication device can thus be maintained in the activated state, and it is possible to reduce a possibility that the user who is to execute the remote operation control feels a sense of discomfort caused by the state in which the user cannot execute the remote operation control. Further, with the system according to the present disclosure, the user is not required to execute a special operation for changing the communication device to the activated state, and convenience of the user thus increases. Further, until the activation condition is satisfied, the communication device is maintained in the inactivated state, and it is thus possible to reduce a frequency (occasions) of the wasteful consumption of the electric power by the communication device.

In one aspect of the system of the present disclosure, the system further comprises an electronic key (26) configured to transmit an electronic key wireless signal including a key identifier assigned in advance.

The vehicle is configured to:
receive the electronic key wireless signal when the electronic key exists within the communication possible range even when the communication device is in the inactivated state;
determine, when the communication device is in the inactivated state and the electronic key wireless signal is received, whether the key identifier included in the electronic key wireless signal matches a vehicle unique identifier stored in advance (Step 210, Step 306, Step 510); and
determine that the activation condition is satisfied when the key identifier and the vehicle unique identifier are determined to match each other.

According to this aspect, the state of the communication device can be changed to the activated state by only bringing about the state in which there exists the user carrying the electronic key having the set identifier matching the vehicle unique identifier within the communication possible range. As a result, it is possible to determine, without requiring a special operation by the user who has approached the vehicle, whether or not the user is a legitimate user. When the user is a legitimate user, the state of the communication device can be changed to the activated state. Further, the user can cause the vehicle to execute the remote operation control by only operating the portable terminal without being required to operate the electronic key. Consequently, the user can smoothly cause the vehicle to execute the remote operation control without switching the held electronic key to the portable terminal.

In one aspect of the system of the present disclosure, the vehicle further includes a drive device (42a) configured to apply a driving force to the vehicle when the drive device is in an actuation state, and to avoid applying the driving force to the vehicle when the drive device is in a non-actuation state,

The portable terminal includes a display (270) of a touch panel type.

The portable terminal is configured to:
display, on the display, a start screen (400) including a predetermined startup operation region when the wireless communication connection with the communication device is established (Step 312); and
transmit a startup signal to the communication device when the user executes a predetermined startup operation in the predetermined startup operation region (Step 314).

When the communication device receives the startup signal under a state in which the drive device is in the non-actuation state (“Yes” at Step 610), the vehicle is configured to start up the drive device, to thereby change a state of the drive device to the actuation state (Step 615).

According to this aspect, the user is required to execute the predetermined startup operation on the start screen of the portable terminal in order to start up the drive device, and it is thus possible to reduce a possibility that the drive device is started up by an erroneous operation of the user.

In one aspect of the system of the present disclosure, the portable terminal is configured to:
display, on the display, a confirmation screen, which includes a predetermined confirmation operation region, and allows the user to confirm the predetermined target position, after the user executes the predetermined startup operation (Step 322); and
transmit a confirmation signal to the communication device when the user executes a predetermined confirmation operation in the confirmation operation region (Step 324).

The vehicle is configured to start control of causing the vehicle to travel toward the predetermined target position when the vehicle receives the confirmation signal (Step 326, “Yes” at Step 810, Step 815).

According to this aspect, in order to start the control of moving the vehicle toward the target position, the user is required to execute the confirmation operation on the confirmation screen of the portable terminal for confirming the target position. The user can thus start the control after the user accepts the target position, and it is also possible to reduce a possibility that the control is started by an erroneous operation of the user.

In one aspect of the system of the present disclosure, the vehicle further includes a drive device (42a) configured to apply a driving force to the vehicle when the drive device is in an actuation state, and to avoid applying the driving force to the vehicle when the drive device is in a non-actuation state.

The vehicle is configured to:
control the drive device so that the driving force is changed based on an operation by the user of an accelerator (41a) provided inside the vehicle, when the drive device is in the actuation state;
maintain the drive device in the actuation state without changing the drive device to the non-actuation state after an arrival time being a time at which the vehicle arrives at the predetermined target position (Step 336, Step 1040); and
invalidate the operation of the accelerator such that the driving device does not apply the driving force to the vehicle even when the accelerator is operated, in a period from the arrival time to a cancellation condition satisfaction time at which a cancellation condition is satisfied, the cancellation condition allowing confirmation that the user holding legitimate qualification has gotten in the vehicle without requiring an operation of the user (Step 336, Step 344, Step 540, Step 1045, Step 1125).

Even when a person who intends to steal the vehicle after arrival of the vehicle at the target position gets in the vehicle, the cancellation condition is not satisfied, and hence the operation on the accelerator by this person is invalidated. As a result, a risk of vehicle theft after arrival of the vehicle at the target position can be reduced. Further, the actuation state of the power source is maintained after the arrival time, and when a user holding the legitimate qualification gets in the vehicle, the invalidation of the operation on the accelerator is cancelled. Thus, the user holding the legitimate qualification can start the vehicle without startup operation.

A vehicle according to at least one embodiment of the present disclosure comprises:

a communication device (25), which is mounted to the vehicle, and is configured to establish a wireless communication connection with a portable terminal (27) to be disabled to wirelessly communicate with the portable terminal when the communication device is in an activated state, and to be disabled to wirelessly communicate with the portable terminal when the communication device is in an inactivated state; and

a travel control device (10, 30, 40, 42, 42a) configured to cause the vehicle to travel such that the vehicle automatically travels to a predetermined target position in accordance with an instruction received by the communication device through the wireless communication with the portable terminal.

The travel control device is configured to monitor, when the communication device is in the inactivated state, whether an activation condition is satisfied, the activation condition being satisfied when a user holding legitimate qualification for driving the vehicle exists within a predetermined communication possible range, which is outside the vehicle, and in which a distance from the vehicle is shorter than a predetermined distance (Step 205, Step 210, Step 304, Step 306, Step 505 to Step 515), and to change a state of the communication device from the inactivated state to the activated state when the activation condition is satisfied (Step 215, Step 308, Step 525).

With the vehicle according to the present disclosure, when the communication between the vehicle and the portable terminal is required, the communication device can be maintained in the activated state, and it is possible to reduce a possibility that the user who is to execute the remote operation control feels a sense of discomfort caused by the state in which the user cannot execute the remote operation control. Further, with the device according to the present disclosure, the user is not required to execute a special operation for changing the communication device to the activated state, and convenience of the user thus increases. Further, until the activation condition is satisfied, the communication device is maintained in the inactivated state, and it is thus possible to reduce a frequency (chances) of the wasteful consumption of the electric power by the communication device.

In the above description, for easier understanding of the present disclosure, the terms and/or reference symbols used in at least one embodiment described below are enclosed in parentheses and assigned to the components of the present disclosure corresponding to the at least one embodiment. However, the constituent elements of the present disclosure are not limited to the at least one embodiment defined by the terms and/or reference symbols. Other objects, other features, and accompanying advantages of the present disclosure are easily understandable from the description of the at least one embodiment of the present disclosure to be given with reference to the following drawings.

### BRIEF DESCRIPTION OF THE DRAWINGS

FIG. 1 is a schematic configuration diagram of a vehicle control system according to an embodiment of the present disclosure.

FIG. 2 is a flowchart for illustrating an overview of an operation of the present disclosure.

FIG. 3 is a sequence diagram of an electronic key, a remote control device, and a portable terminal.

FIG. 4A is an explanatory diagram of a start screen displayed on the portable terminal.

FIG. 4B is an explanatory diagram of a confirmation screen displayed on the portable terminal.

FIG. 4C is an explanatory diagram of an operation screen displayed on the portable terminal.

FIG. 4D is an explanatory diagram of an end screen displayed on the portable terminal.

FIG. 5 is a flowchart for illustrating a key matching routine executed by a CPU of a matching ECU.

FIG. 6 is a flowchart for illustrating a startup control routine executed by the CPU of the matching ECU.

FIG. 7 is a flowchart for illustrating a position and path determination routine executed by a CPU of a parking ECU.

FIG. 8 is a flowchart for illustrating a start control routine executed by the CPU of the parking ECU.

FIG. 9 is a flowchart for illustrating a remote operation control routine executed by the CPU of the parking ECU.

FIG. 10 is a flowchart for illustrating an arrival determination routine executed by the CPU of the parking ECU.

FIG. 11 is a flowchart for illustrating a drive control routine executed by a CPU of a drive ECU.

### DESCRIPTION OF THE EMBODIMENTS

<Configuration>

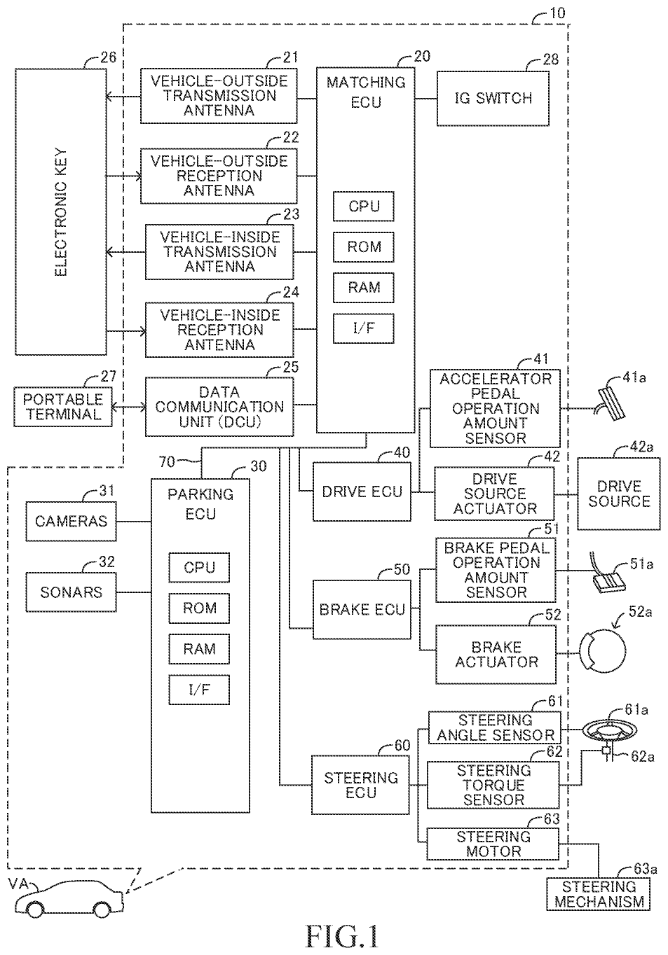

As illustrated in FIG. 1, a vehicle control system according to an embodiment of the present disclosure includes a vehicle control device 10 (hereinafter referred to as “the present control device 10”) mounted (applied) to a vehicle VA, an electronic key 26, and a portable terminal 27.

The present control device 10 includes a matching ECU 20, a parking ECU 30, a drive ECU 40, a brake ECU 50, and a steering ECU 60. These ECUs 20, 30, 40, 50, and 60 are connected to each other for mutually transmitting and receiving data through a controller area network (CAN) 70.

ECU is an abbreviation for an electric control unit. The ECU is an electronic control circuit including a microcomputer as a main component. The microcomputer includes, for example, a CPU, a ROM, a RAM, and an interface. The CPU executes instructions (routines) stored in the memory (ROM) to implement various functions. All or some of the above-mentioned ECUs 20, 30, 40, 50, and 60 may be integrated into one ECU.

The present control device 10 includes a vehicle-outside transmission antenna 21, a vehicle-outside reception antenna 22, a vehicle-inside transmission antenna 23, a vehicle-inside reception antenna 24, and a data communication unit (hereinafter referred to as “DCU,” and sometimes referred to as “communication unit”, “communication device” and “communication module”) 25. These components are connected to the matching ECU 20.

The vehicle-outside transmission antenna 21 is an antenna configured to transmit a predetermined wireless signal (for example, a request signal) toward the outside of the vehicle VA (vehicle-outside). The vehicle-outside reception antenna 22 is an antenna configured to receive a wireless signal (for example, response signal) transmitted from a device present outside the vehicle. The vehicle-inside transmission antenna 23 is an antenna configured to transmit a predetermined wireless signal (for example, the request signal) toward the inside of the vehicle VA (vehicle-inside). The vehicle-inside reception antenna 24 is an antenna configured to receive a wireless signal (for example, the response signal) transmitted from a device present inside the vehicle.

The electronic key 26 is a key for the vehicle VA, is carried by a driver (user) of the vehicle VA, and is used, for example, when a door (not shown) of the vehicle VA is to be locked and unlocked. When the electronic key 26 receives the request signal from the vehicle VA through the wireless communication, the electronic key 26 transmits, through the wireless communication, a response signal (electronic key wireless signal) including a key ID (hereinafter sometimes referred to as “identifier”) being an identifier assigned in advance to the electronic key 26. When the electronic key 26 is present outside the vehicle, and is present within a transmission range of the wireless signal of the vehicle-outside transmission antenna 21, the electronic key 26 receives the request signal transmitted from the vehicle-outside transmission antenna 21. The vehicle-outside reception antenna 22 receives the response signal transmitted by the electronic key 26. In order for the vehicle-outside reception antenna 22 to receive the response signal, the electronic key 26 that has transmitted the response signal is required to exist in a reception possible range (communication possible range) of the wireless signal of the vehicle-outside reception antenna 22. Meanwhile, when the electronic key 26 is present inside the vehicle, the electronic key 26 receives the request signal transmitted from the vehicle-inside transmission antenna 23, and the vehicle-inside reception antenna 24 receives the response signal transmitted by the electronic key 26.

The matching ECU 20 is configured to transmit the request signal toward the outside of the vehicle and the inside of the vehicle. Further, the matching ECU 20 is configured to be capable of receiving the response signal from the electronic key 26. When the matching ECU 20 receives the response signal, the matching ECU 20 identifies through which of the vehicle-outside reception antenna 22 and the vehicle-inside reception antenna 24 the response signal is received. When the response signal is received through the vehicle-outside reception antenna 22, the matching ECU 20 determines that the electronic key 26 that has transmitted the response signal is present outside the vehicle. When the response signal is received through the vehicle-inside reception antenna 24, the matching ECU 20 determines that the electronic key 26 that has transmitted the response signal is present inside the vehicle. The matching ECU 20 determines whether or not the key ID included in the received response signal matches a vehicle unique ID (vehicle unique identifier) being an identifier set to the vehicle VA in advance. That is, the matching ECU 20 executes key matching, and communicates a result thereof with other ECUs through the CAN 70.

When the DCU 25 is in the activated state, and the wireless communication connection has not been established, the DCU 25 is configured to search for a device of a connection destination, and to establish, when a retrieved device is a device registered (paired) in advance, the wireless communication connection with the device. When the portable terminal (for example, a smartphone or a portable tablet) 27 being a communication apparatus carried by the user has been registered to the DCU 25 in advance, and the DCU 25 is activated, and founds the portable terminal 27, the wireless communication connection is established between the DCU 25 and the portable terminal 27. When the wireless communication connection is established, data communication can be executed between the DCU 25 and the portable terminal 27. The DCU 25 communicates with the portable terminal 27 through widely-known near field communication (for example, Bluetooth (trademark)). When the DCU 25 is in the inactivated state, no wireless connection is established, and the DCU 25 does not search for a device being the connection destination, and cannot thus communicate with the portable terminal 27.

Further, the present control device 10 includes an ignition (IG) switch (also referred to as “startup switch” or “ready switch”) 28. The IG switch 28 is connected to the matching ECU 20. When the user operates the IG switch 28 at an OFF position, the IG switch 28 is changed from the OFF position to an ON position. When the user operates the IG switch 28 at the ON position, the IG switch 28 is changed from the ON position to the OFF position.

Further, the present control device 10 includes a plurality of cameras 31 and a plurality of sonars 32. The cameras 31 and the sonars 32 are connected to the parking ECU 30.

The plurality of cameras 31 include a front camera, a rear camera, a left side camera, and a right side camera. Each of the plurality of cameras 31 takes an image of a region described below to generate image data each time a predetermined period elapses, and transmits the image data to the parking ECU 30. The front camera takes an image of a region on a front side of the vehicle VA. The rear camera takes an image of a region on a front side of the vehicle VA. The left side camera takes an image of a region on a left side of the vehicle VA. The right side camera takes an image of a region on a right side of the vehicle VA.

The plurality of sonars 32 include a front sonar, a rear sonar, a left side sonar, and a right side sonar. Each of the plurality of sonars 32 transmits a sound wave to a region described below, and receives a reflected wave of the sound wave reflected by an object. Each of the sonars 32 transmits information (that is, sonar data) on the transmitted sound wave and the received reflected wave to the parking ECU 30 each time a predetermined period elapses. The front sonar, the rear sonar, the left side sonar, and the right side sonar transmit the sound waves to a region on the front side of the vehicle VA, a region on the front side of the vehicle VA, a region on the left side of the vehicle VA, and a region on the right side of the vehicle VA, respectively.

The drive ECU 40 is connected to an accelerator pedal operation amount sensor 41 and a drive source actuator 42.

The accelerator pedal operation amount sensor 41 detects an accelerator pedal operation amount AP being an operation amount of an accelerator pedal 41a, and outputs a signal indicating the accelerator pedal operation amount AP. The drive ECU 40 acquires the accelerator pedal operation amount AP based on the signal generated by the accelerator pedal operation amount sensor 41. The accelerator pedal 41a is sometimes referred to as “accelerator.”

The drive source actuator 42 is connected to a drive source (such as an electric motor and an internal combustion engine) 42a that generates a driving force to be applied to the vehicle. The drive source 42a is sometimes referred to as “drive device.” The drive ECU 40 controls the drive source actuator 42 to change an operation state of the drive source 42a, to thereby adjust the driving force to be applied to the vehicle VA. The drive ECU 40 controls the drive source actuator 42 such that the driving force applied to the vehicle increases as the accelerator pedal operation amount AP increases.

When a startup condition described below is satisfied, the drive source 42a is started up, and the state of the drive source 42a is changed from a non-actuation state to an actuation state. The drive source 42a in the actuation state can apply a driving force to the vehicle VA. The drive source 42a in the non-actuation state cannot apply the driving force to the vehicle VA. When the IG switch 28 is changed from the ON position to the OFF position, the state of the drive source 42a is changed from the actuation state to the non-actuation state. The state in which the drive source 42a is in the actuation state is referred to as “ignition on.” The state in which the drive source 42a is in the non-actuation state is referred to as “ignition off.”

The brake ECU 50 is connected to a brake pedal operation amount sensor 51 and a brake actuator 52.

The brake pedal operation amount sensor 51 detects a brake pedal operation amount BP being an operation amount of a brake pedal 51a, and outputs a signal indicating the brake pedal operation amount BP. The brake ECU 50 acquires the brake pedal operation amount BP based on the signal generated by the brake pedal operation amount sensor 51.

The brake actuator 52 is connected to widely-known friction brake apparatus 52a of a hydraulic type. The brake ECU 50 controls the brake actuator 52 to change a friction braking force generated by each brake apparatus 52a, thereby being capable of adjusting a braking force to be applied to the vehicle. The brake ECU 50 controls the brake actuator 52 such that the braking force applied to the vehicle increases as the brake pedal operation amount BP increases.

The steering ECU 60 is connected to a steering angle sensor 61, a steering torque sensor 62, and a steering motor 63.

The steering angle sensor 61 detects, as a steering angle θs, a rotation angle of a steering wheel 61a with respect to a neutral position, and generates a signal indicating the steering angle θs. The steering ECU 60 acquires the steering angle θs based on the signal generated by the steering angle sensor 61.

The steering torque sensor 62 detects a steering torque Tr indicating torque acting on a steering shaft 62a coupled to the steering wheel 61a, and generates a signal indicating the steering torque Tr. The steering ECU 60 acquires the steering torque Tr based on the signal generated by the steering torque sensor 62.

The steering motor 63 is incorporated so that the torque can be transmitted to “a steering mechanism 63a including the steering wheel 61a, the steering shaft 62a, a steering gear mechanism, and the like” of the vehicle VA. The steering motor 63 generates torque having the direction, the magnitude, and the like controlled by the steering ECU 60 in accordance with “electric power supplied from a vehicle battery (not shown).” A steering assist torque is generated by this torque, or left and right steered wheels are steered (turned).

The steering ECU 60 uses the steering motor 63 to generate the steering assist torque in accordance with the steering torque Tr in a normal state. Further, when the steering ECU 60 receives “a steering command including a target steering angle” from the parking ECU 30, the steering ECU 60 controls the steering motor 63 so that the steering angle θs matches “a target steering angle included in the received steering command,” to thereby automatically turn the steered wheels.

In the ignition-off state, the matching ECU 20 and the antennas 21 to 24 are activated, and the DCU 25 and the ECUs 30 to 60 are not activated. The vehicle-outside reception antenna 22 can receive the response signal from the electronic key 26 even when the DCU 25 is not activated. Further, in the ignition-on state, all of the matching ECU 20, the antennas 21 to 24, the DCU 25, and the ECUs 30 to 60 are activated.

(Overview of Operation)

The vehicle control system according to this embodiment is configured to be capable of achieving control (remote operation control) of using the present control device 10 and the portable terminal 27 to cause the vehicle VA to travel to a predetermined target stop position (target position) based on the operation of the portable terminal 27 by the user existing outside the vehicle. In order for the remote operation control to be executed, the data communication is required between the portable terminal 27 and the DCU 25. However, in the ignition-off state, the DCU 25 is in the inactivated state in order to reduce the electric power consumption. Thus, in this state, the remote operation control cannot be started.

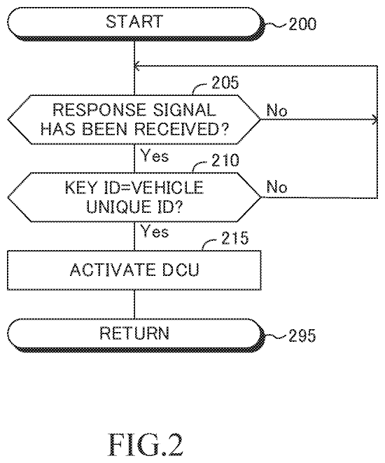

Thus, the present control device 10 is configured to operate as schematically illustrated in a flowchart of FIG. 2. The present control device 10 is always monitoring whether or not the vehicle-outside reception antenna 22 has received the response signal transmitted by the electronic key 26 (Step 205).

When the present control device 10 determines that the response signal is received from the electronic key 26 (Yes in Step 205), the present control device 10 executes the key matching of determining whether or not the key ID included in the response signal matches the vehicle unique ID set in advance to the present control device 10 (Step 210). When the present control device 10 determines that the key ID matches the vehicle unique ID (that is, the key matching is successful) (Yes in Step 210), the present control device 10 activates the DCU 25, to thereby change the state of the DCU 25 to the activated state (Step 215). When the DCU 25 is brought into the activated state, the DCU 25 establishes the wireless communication connection with the portable terminal 27, thereby being capable of communicating with the portable terminal 27.

When the present control device 10 receives the response signal, and the key matching is successful, the present control device 10 can confirm, without requiring a special operation of the user carrying the electronic key 26 having the assigned key ID matching the vehicle unique ID, that the user exists within a range which is outside the vehicle VA and in which the distance from the vehicle VA is shorter than a predetermined distance. That is, the reception of the response signal and the success of the key matching mean that a user (hereinafter referred to as “legitimate user”) holding the legitimate qualification for driving the vehicle VA exists within the reception possible region of the vehicle-outside reception antenna 22.

Thus, when the present control device 10 receives the response signal, and the key matching is successful, the present control device 10 determines that the activation condition is satisfied, and thus changes the state of the DCU 25 from the non-activation state to the activation state, to thereby establish the wireless communication connection between the DCU 25 and the potable terminal 27. After this time, the user operates the portable terminal 27 (details of the operation are described below), to thereby be capable of starting the remote operation control. As a result, the user is not required to operate the electronic key when the user starts the remote operation control. Thus, the user can smoothly start the remote operation control by only operating the portable terminal 27 without switching the held electronic key to the portable terminal.

When the legitimate user starts the remote operation control, the user approaches the vehicle VA. The present control device 10 automatically activates the DCU 25 in this case. Consequently, it is possible to reduce a possibility that the DCU 25 wastefully consumes the electric power, and it is also possible to prevent occurrence of a state in which the DCU 25 is not activated when the user wants to start the remote operation control. Further, the user is not required to execute a special operation to activate the DCU 25 when the user executes the remote operation control, and convenience for the user thus increases.

(Operation Example)

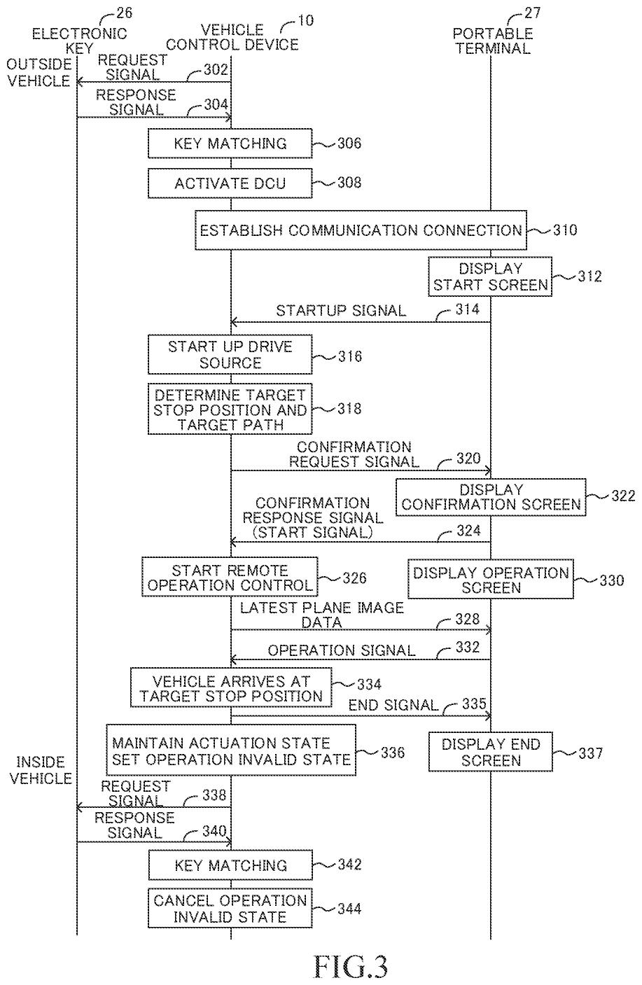

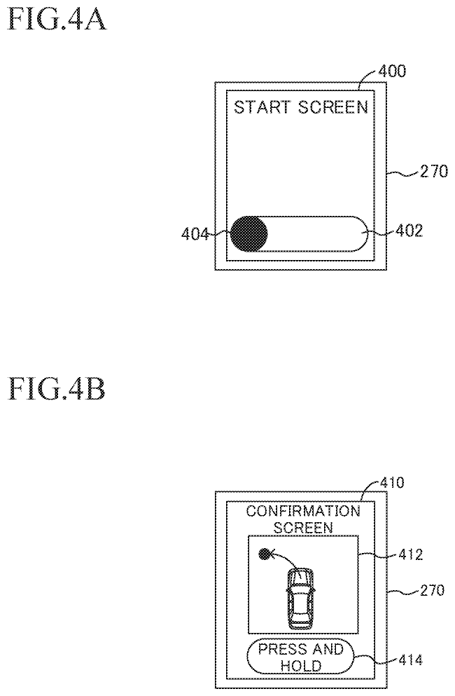

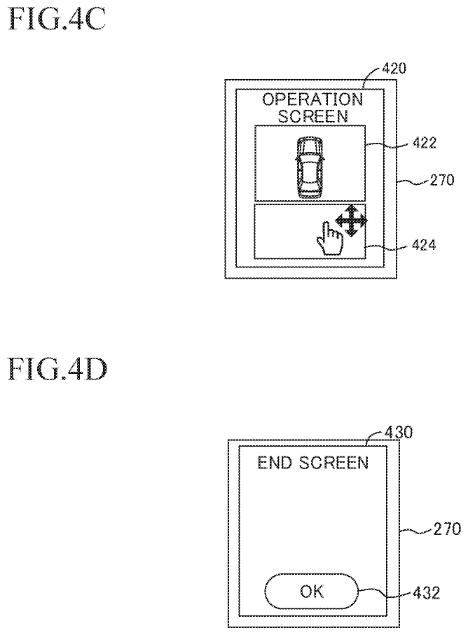

With reference to FIG. 3 and FIG. 4A to FIG. 4D, a specific description is given of an operation of the present control device 10, the electronic key 26, and the portable terminal 27.

The present control device 10 always transmits a request signal from the vehicle-outside transmission antenna 21 and the vehicle-inside transmission antenna 23 each time a predetermined period elapses irrespective of whether the state is the ignition-on state or the ignition-off state (Step 302). It is now assumed that the user is present outside the vehicle, the electronic key 26 and the portable terminal 27 are also present outside the vehicle, and a remote control application program of the portable terminal 27 is activated.

In this state, when the user approaches the vehicle VA to a certain degree, the electronic key 26 receives the request signal, and transmits the response signal including the key ID assigned in advance (Step 304).

When the vehicle-outside reception antenna 22 receives the response signal, the present control device 10 executes the key matching described above (Step 306). When the key matching is successful, the present control device 10 determines that the activation condition described above is satisfied, and activates the DCU 25 (Step 308). When the DCU 25 is activated, the DCU 25 searches for a device being the connection destination, and when the retrieved device has been registered to (paired with) the DCU 25 in advance, the wireless communication is established between the DCU 25 and the device. In this case, the portable terminal 27 registered in advance is retrieved as the device being the connection destination, and the wireless communication connection is established between the DCU 25 and the portable terminal 27 (Step 310). As a result, the state of the DCU 25 transitions from “the inactivated state in which the DCU 25 does not search for a device being the connection destination, and the communication with the portable terminal 27 is thus impossible” to “the communication established state in which the wireless communication connection with the portable terminal 27 is established, and the data communication is possible.” When the wireless communication connection is established, the portable terminal 27 displays a start screen 400 of FIG. 4A on a display 270 of the portable terminal 27 (see FIG. 4A to FIG. 4D) (Step 312). The display 270 is a display device of a touch panel type.

As illustrated in FIG. 4A, the start screen 400 includes a slide operation region 402. In an initial state of the start screen 400, an operation display element 404 is positioned at a left end of the slide operation region 402. When the user outside the vehicle operates the portable terminal 27 in such a manner as to slide the operation display element 404 to a right end of the slide operation region 402, the portable terminal 27 determines that a predetermined startup operation has been executed, and transmits a startup signal to the DCU 25 (Step 314).

Incidentally, in a case in which the drive source 42a is in the non-actuation state, when any one of a condition S1 and a condition S2 described below is satisfied, the present control device 10 determines that the startup condition is satisfied, and changes the state of the drive source 42a from the non-actuation state to the actuation state (that is, the state of the vehicle VA is changed from the ignition-off state to the ignition-on state).

Condition S1: A condition satisfied when the electronic key 26 is present inside the vehicle, the key matching is successful, and the IG switch 28 is changed from an OFF position to an ON position.

Condition S2: A condition satisfied when the electronic key 26 is present outside the vehicle, the key matching is successful, and the startup operation is executed on the portable terminal 27.

The case in which the DCU 25 receives the startup signal is a case in which the electronic key 26 is present outside the vehicle, the key matching is successful, and the startup operation is executed on the portable terminal 27. Thus, when the DCU 25 receives the startup signal, the present control device 10 determines that the startup condition is satisfied as a result of the satisfaction of the condition S2. Thus, the present control device 10 starts up the drive source 42a, to thereby cause the state of the drive source 42a to transition from the non-actuation state to the actuation state (Step 316).

When the drive source 42a is an internal combustion engine, a starter motor (not shown) rotates a crankshaft of the internal combustion engine, to thereby start up the internal combustion engine. Meanwhile, when the drive source 42a is an electric motor, a relay circuit (not shown) is controlled so that the drive source 42a is changed from “a non-current supply state in which electrical connection between the electric motor and a battery (not shown) is shut off” to “a current supply state in which the electric motor and the battery (not shown) are electrically connected to each other,” to thereby start up the electric motor. When the drive source 42a is formed of an internal combustion engine and an electric motor (when the vehicle VA is a hybrid vehicle), the electric motor that generates at least a driving force for starting the vehicle is started up.

Further, the present control device 10 determines the target stop position and a target path based on the image data and the sonar data (Step 318). After that, the present control device 10 transmits a confirmation request signal to the portable terminal 27 (Step 320). The confirmation request signal includes image data relating to a confirmation image. The confirmation image is an image formed by plotting (superimposing) the target stop position and the target path on “a plane image at the time when a region within a predetermined range from the vehicle VA is viewed from directly above,” and is generated based on the image data generated by the plurality of cameras 31.

When the portable terminal 27 receives the confirmation request signal, the portable terminal 27 displays a confirmation screen 410 of FIG. 4B on the display 270 (Step 322). As illustrated in FIG. 4B, the confirmation screen 410 includes a stop position display region 412 and a press-and-hold button 414. In the stop position display region 412, the confirmation image is displayed. When the user views the confirmation image displayed in the stop position display region 412, and accepts the target stop position and the target path, the user touches the press-and-hold button 414. When the press-and-hold button 414 is touched for a period equal to or longer than a predetermined period, the portable terminal 27 determines that the predetermined start operation has been executed, and transmits a confirmation response signal (start signal) to the DCU 25 (Step 324).

When the DCU 25 receives the confirmation response signal (start signal), the present control device 10 determines that the predetermined start condition is satisfied, and thus starts remote operation control (Step 326). The present control device 10 transmits the latest plane image data to the portable terminal 27 each time a predetermined period elapses during the execution of the remote operation control (Step 328). When the start operation is executed on the confirmation screen 410, the portable terminal 27 displays an operation screen 420 (see FIG. 4C) on the display 270 (Step 330). As illustrated in FIG. 4C, the operation screen 420 includes a plane image display region 422 and an operation region 424. In the plane image display region 422, there is displayed a plane image based on the latest plane image data received by the portable terminal 27. The image displayed in the plane image display region 422 is updated each time the latest plane image data is received. When the user is tracing the operation region 424 with the finger, and the touched position in the operation region 424 is thus continuously changing, the portable terminal 27 continues to transmit an operation signal to the DCU 25 each time a predetermined period elapses (Step 332).

When the present control device 10 once starts the remote operation control, the present control device 10 causes the vehicle VA to travel along the target path as long as the operation signal is received until the vehicle VA arrives at the target stop position. In other words, the user is required to continue to trace the operation region 424 until the vehicle VA arrives at the target stop position. When the vehicle VA arrives at a deceleration start position being a position before the target stop position by a predetermined distance along the target path, the present control device 10 starts decelerating the vehicle VA, and stops the vehicle VA at the target stop position.

When the present control device 10 determines that the vehicle VA arrives at the target stop position (Step 334), the present control device 10 transmits an end signal to the portable terminal 27 (Step 335). Further, the present control device 10 does not cause the drive source 42a to transition to the non-actuation state, but maintains the drive source 42a in the actuation state, and sets the state of the drive source 42a to the specific state (state being the actuation state and the operation invalid state) (Step 336).

When the portable terminal 27 receives the end signal, the portable terminal 27 displays an end screen 430 (see FIG. 4D) on the display 270. As illustrated in FIG. 4D, the end screen 430 includes an OK button 432. When the OK button 432 is operated, the portable terminal 27 finishes the remote control application program. The user can recognize that the vehicle VA arrives at the target stop position, and the remote operation control has thus been finished when the end screen 430 is displayed.

The user gets in the vehicle VA stopping at the target stop position. When the user has gotten in the vehicle VA, the electronic key 26 (and the portable terminal 27) is present inside the vehicle. When the electronic key 26, which is now present inside the vehicle, receives the request signal transmitted from the vehicle-inside transmission antenna 23 (Step 338), the electronic key 26 transmits the response signal (Step 340). When the vehicle-inside reception antenna 24 receives the response signal, the present control device 10 executes the key matching (Step 342).

Incidentally, when both of the following condition K1 and condition K2 are satisfied, the present control device 10 determines that a cancellation condition is satisfied.

Condition K1: A condition satisfied when the vehicle-inside reception antenna 24 receives the response signal.

Condition K2: A condition satisfied when the key ID included in the response signal received by the vehicle-inside reception antenna 24 and the vehicle unique ID set in advance to the present control device 10 match each other.

When the key matching is successful in Step 342, both of the condition K1 and the condition K2 are satisfied, and the cancellation condition is thus satisfied. When the cancellation condition is satisfied, the present control device 10 cancels the operation invalid state (Step 344).

As described above, the present control device 10 activates the DCU 25 when the activation condition is satisfied by the legitimate user approaching the vehicle VA. Thus, this vehicle control system can reduce a frequency (occasions) of the wasteful consumption of the electric power by the DCU 25. Further, this vehicle control system can prevent the user who is to execute the remote operation control from feeling a sense of discomfort caused by the state in which the user cannot execute the remote operation control, and can start the remote operation control without requiring a special operation by the user for changing the DCU 25 to the activated state. Further, the user can start the remote operation control without an operation on the electronic key 26, and thus the user can start the remote operation control by only operating the portable terminal 27 without switching the held electronic key 26 to the portable terminal 27.

Further, when the user executes the startup operation on the start screen 400 displayed on the portable terminal 27, the present control device 10 starts up the drive source 42a. As a result, it is possible to reduce a possibility that the drive source 42a is started up by an erroneous operation of the user.

Further, when the user executes the start operation on the confirmation screen 410 displayed on the portable terminal 27, the present control device 10 starts the remote operation control. As a result, it is possible to reduce a possibility that the remote operation control is started by an erroneous operation of the user. Further, the vehicle VA can be caused to travel toward the target stop position accepted by the user, and it is possible to cause the vehicle VA to travel along the target parking path accepted by the user.

Further, the present control device 10 sets the state of the drive source 42a to the specific state in the period from the arrival of the vehicle VA at the target stop position to the satisfaction of the cancellation condition, and it is thus possible to eliminate necessity of the startup operation while reducing the risk of theft of the vehicle VA.

(Specific Operation)

<Key Matching Routine>

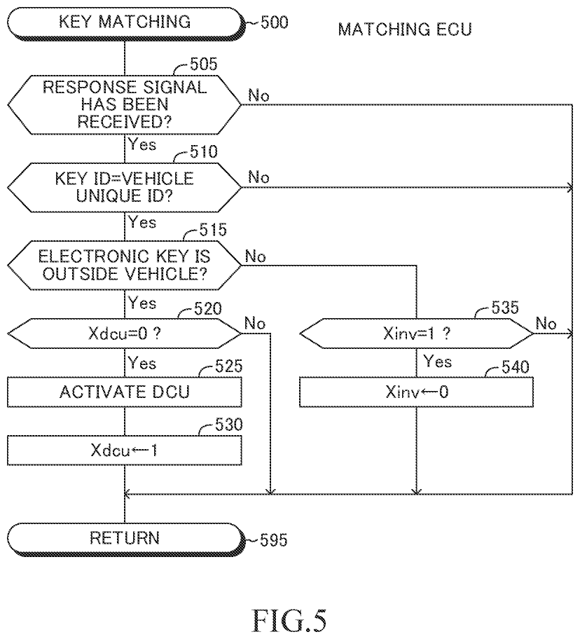

The CPU of the matching ECU 20 (“first CPU” hereinafter refers to the CPU of the matching ECU 20 unless otherwise specified) executes a key matching routine illustrated in a flowchart of FIG. 5 each time a predetermined period elapses. The matching ECU 20 is activated even in the ignition-off state, and thus the first CPU always executes this routine irrespective of whether the state is the ignition-off state or the ignition-on state.

Thus, the first CPU starts processing from Step 500 of FIG. 5 at a predetermined timing, proceeds to Step 505, and determines whether or not the response signal has been received from the electronic key 26 in a period from a time at which this routine has been executed previously to the current time.

When the response signal has not been received in that period, the first CPU makes a determination of “No” in Step 505, proceeds to Step 595, and temporarily finishes this routine.

Meanwhile, when the first CPU has received the response signal in the above-mentioned period, the first CPU makes a determination of “Yes” in Step 505, and proceeds to Step 510. In Step 510, the first CPU determines whether or not the key ID included in the received response signal and the vehicle unique ID stored in advance in the ROM of the matching ECU 20 match each other.

When the key ID and the vehicle unique ID do not match each other, the first CPU makes a determination of “No” in Step 510, proceeds to Step 595, and temporarily finishes this routine.

Meanwhile, when the key ID and the vehicle unique ID match each other, the first CPU makes a determination of “Yes” in Step 510, and proceeds to Step 515. In Step 515, the first CPU determines whether or not the electronic key 26 that has transmitted the response signal is outside the vehicle. More specifically, when the vehicle-outside reception antenna 22 has received the response signal, the first CPU determines that the electronic key 26 is present outside the vehicle. When the vehicle-inside reception antenna 24 has received the response signal, the first CPU determines that the electronic key 26 is present inside the vehicle.

When the electronic key 26 is present outside the vehicle, the first CPU makes a determination of “Yes” in Step 515, and determines whether or not the value of an activation flag Xdcu is “0.” The value of the activation flag Xdcu is set to “1” when the DCU 25 has been activated (see Step 530 below). The value of the activation flag Xdcu is set to “0” when the DCU 25 has not been activated. When the IG switch 28 is changed from the ON position to the OFF position, the DCU 25 is brought into the inactivated state, and the value of the activation flag Xdcu is thus set to “0.”

When the value of the activation flag Xdcu is “0,” the first CPU makes a determination of “Yes” in Step 520, and executes processing in Step 525 and Step 530.

Step 525: The first CPU activates the DCU 25.

Step 530: The first CPU sets the value of the activation flag Xdcu to “1.”

After that, the first CPU proceeds to Step 595, and temporarily finishes this routine. When the DCU 25 is activated, the DCU 25 is brought into the activated state in which the DCU 25 establishes the wireless communication connection with the portable terminal 27, thereby being capable of communicating with the portable terminal 27.

Meanwhile, when the first CPU proceeds to Step 520, and the value of the activation flag Xdcu is “1,” the first CPU makes a determination of “No” in Step 520, proceeds to Step 595, and temporarily finishes this routine.

Meanwhile, when the first CPU proceeds to Step 515, and the electronic key 26 is present inside the vehicle, the first CPU makes a determination of “No” in Step 515, and proceeds to Step 535. In Step 535, the first CPU determines whether or not the value of an invalidity flag Xinv is “1.”

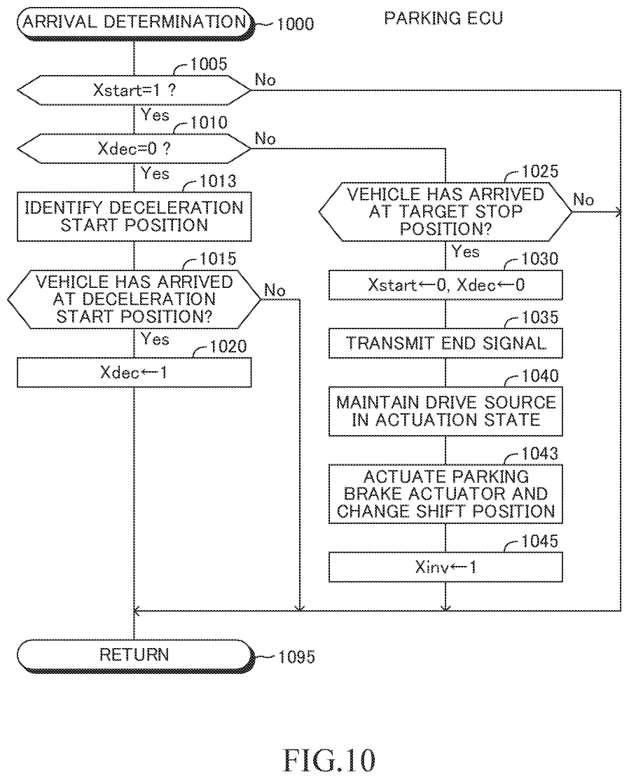

The value of the invalidity flag Xinv is set to “1” when the state of the vehicle VA is in the operation invalid state (see Step 1045 of FIG. 10). The value thereof is set to “0” when the state of the vehicle VA is not in the operation invalid state (see Step 540). The value of the invalidity flag Xinv is set to “0” by an initial routine executed by the CPU when the IG switch 28 is changed from the OFF position to the ON position.

When the value of the invalidity flag Xinv is “1,” the first CPU makes a determination of “Yes” in Step 535, proceeds to Step 540, and sets the value of the invalidity flag Xinv to “0.” As a result, the operation invalid state is cancelled. After that, the first CPU proceeds to Step 595, and temporarily finishes this routine.

Meanwhile, when the value of the invalidity flag Xinv is “1,” the first CPU makes a determination of “No” in Step 535, proceeds to Step 595, and temporarily finishes this routine.

<Startup Control Routine>

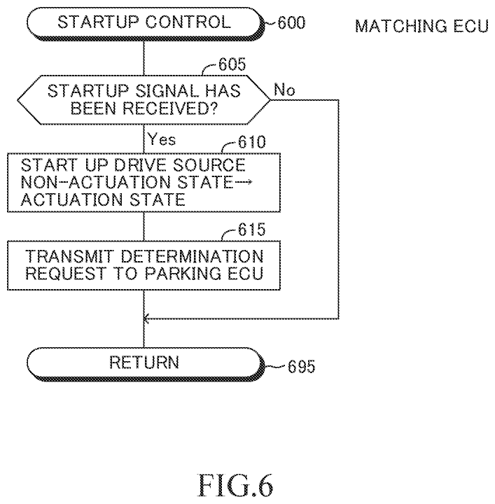

The first CPU executes a startup control routine of FIG. 6 illustrated as a flowchart each time a predetermined period elapses. This routine is a routine for starting up the drive source 42a, and the first CPU thus executes this routine in the ignition-off state.

Thus, the first CPU starts processing from Step 600 of FIG. 6 at a predetermined timing, proceeds to Step 605, and determines whether or not the DCU 25 has received the startup signal from the portable terminal 27 in a period from a time at which this routine has been executed previously to the current time.

When the DCU 25 has not received the startup signal in that period, the first CPU makes a determination of “No” in Step 605, proceeds to Step 695, and temporarily finishes this routine.

Meanwhile, when the DCU 25 has received the startup signal in the above-mentioned period, the first CPU makes a determination of “Yes” in Step 605, and executes the processing in Step 610 and Step 615 in this order.

Step 610: The first CPU starts up the drive source 42a, to thereby cause the drive source 42a to transition from the non-actuation state to the actuation state.

Step 615: The first CPU transmits a determination request for causing the parking ECU 30 to determine the target stop position and the target path to the parking ECU 30.

After that, the first CPU proceeds to Step 695, and temporarily finishes this routine.

<Position and Path Determination Routine>

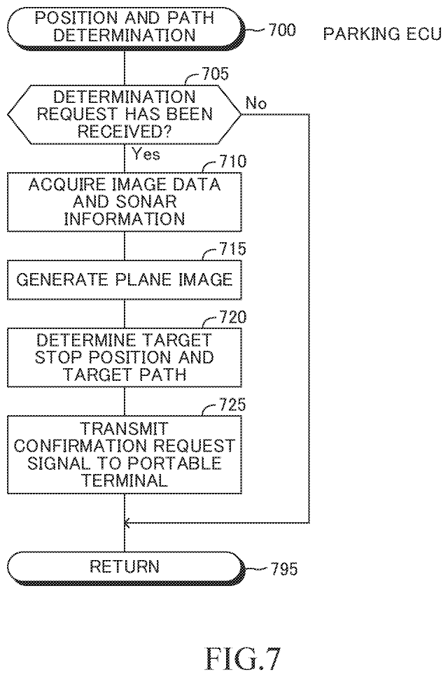

The CPU of the parking ECU 30 (“second CPU” hereinafter refers to the CPU of the parking ECU 30 unless otherwise specified) executes a position and path determination routine illustrated in a flowchart of FIG. 7 each time a predetermined period elapses. The parking ECU 30 is not activated in the ignition-off state, and is activated in the ignition-on state. Thus, the second CPU executes this routine in the ignition-on state.

Thus, the second CPU starts processing from Step 700 of FIG. 7 at a predetermined timing, proceeds to Step 705, and determines whether or not the determination request has been received from the matching ECU 20 in a period from a time at which this routine has been executed previously to the current time.

When the second CPU receives the determination request from the matching ECU 20 in the above-mentioned period, the second CPU makes a determination of “Yes” in Step 705, and executes processing in Step 710 to Step 725 in this order.

Step 710: The second CPU acquires the image data from the cameras 31 and the sonar data from the sonars 32.

Step 715: The second CPU generates the plane image based on the image data.

Step 720: The second CPU identifies obstacles present around the vehicle VA based on the image data and the sonar data, to thereby determine the target path and the target stop position. The target stop position is determined to be a position at which there are not obstacles in a predetermined range around the vehicle VA parking at the target stop position, and a position at which the vehicle VA can arrive without contact with obstacles. The predetermined range is set to such a range that the door of the vehicle VA stopping at the target stop position can be opened. The target path is a path along which the vehicle VA can arrive at the target stop position, and the vehicle VA can travel without contact with the obstacles. Further, the target stop position and the target path are determined so that a front-and-rear direction (front-and-rear direction upon stopping) of the vehicle VA stopping at the target stop position is perpendicular to a current front-and-rear direction of the vehicle VA (current front-and-rear direction). The target stop position on the confirmation screen 410 of FIG. 4B is determined so that the front-and-rear direction upon stopping is rotated counterclockwise by 90 degrees from the current front-and-rear direction. The target path is determined so that the vehicle VA travels while turning left.

Step 725: The second CPU transmits, to the portable terminal 27, the confirmation request signal including the image data relating to the confirmation image formed by superimposing the target stop position and the target path on the plane image generated in Step 715.

After that, the second CPU proceeds to Step 795, and temporarily finishes this routine.

Meanwhile, when the second CPU proceeds to Step 705, and has not received the determination request from the matching ECU 20, the second CPU makes a determination of “No” in Step 705, proceeds to Step 795, and temporarily finishes this routine.

<Start Control Routine>

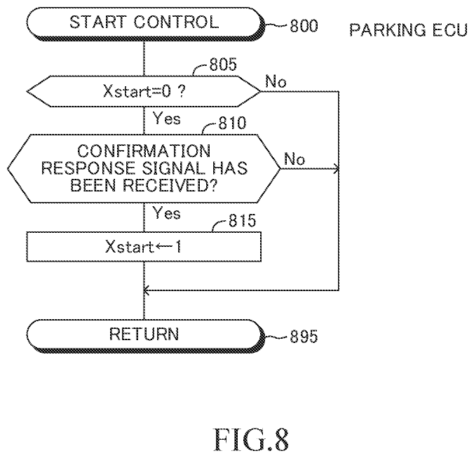

The second CPU executes a start control routine of FIG. 8 illustrated as a flowchart each time a predetermined period elapses. The second CPU executes this routine in the ignition-on state.

Thus, the second CPU starts processing from Step 800 of FIG. 8 at a predetermined timing, proceeds to Step 805, and determines whether or not the value of a start flag Xstart is “0.” The value of the start flag Xstart is set to “1” when the remote operation control is started (see Step 815). The value thereof is set to “0” when the vehicle VA arrives at the target stop position, and the remote operation control is finished (see Step 1030 of FIG. 10). The value of the start flag Xstart is set to “0” by the initial routine.

When the value of the start flag Xstart is “0,” the second CPU makes a determination of “Yes” in Step 805, and proceeds to Step 810. In Step 810, the second CPU determines whether or not the confirmation response signal (start signal) has been received from the portable terminal 27 in a period from a time when this routine has been previously executed to the current time.

When the confirmation response signal has been received from the portable terminal 27 in the above-mentioned period, the second CPU makes a determination of “Yes” in Step 810, proceeds to Step 815, and sets the value of the start flag Xstart to “1.” After that, the second CPU proceeds to Step 895, and temporarily finishes this routine.

Meanwhile, when the confirmation response signal has not been received from the portable terminal 27 in the above-mentioned period, the second CPU makes a determination of “No” in Step 810, proceeds to Step 895, and temporarily finishes this routine.

Meanwhile, when the second CPU proceeds to Step 805, and the value of the start flag Xstart is “1,” the second CPU makes a determination of “No” in Step 805, proceeds to Step 895, and temporarily finishes this routine.

<Remote Operation Control Routine>

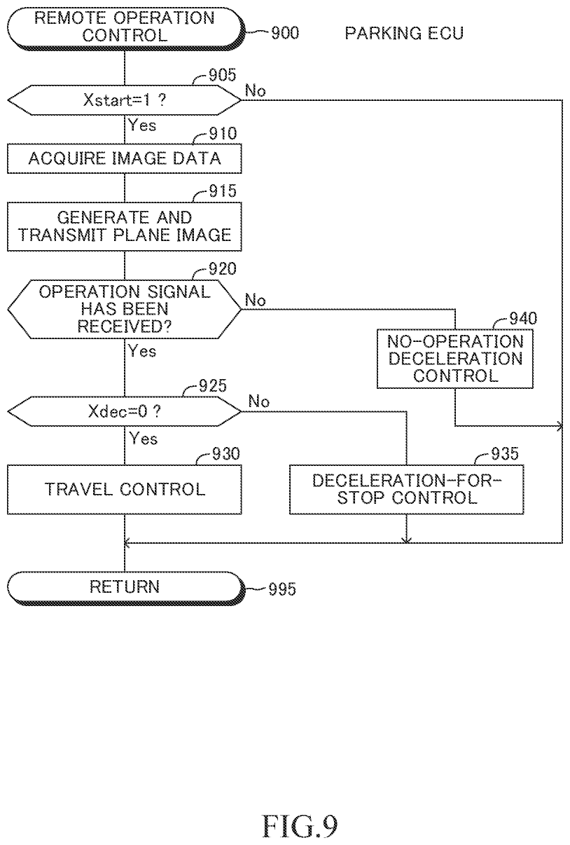

The second CPU executes a remote operation control routine of FIG. 9 illustrated as a flowchart each time a predetermined period elapses. The second CPU executes this routine in the ignition-on state.

Thus, the second CPU starts processing from Step 900 at a predetermined timing, proceeds to Step 905, and determines whether or not the value of the start flag Xstart is “1.” When the value of the start flag Xstart is “0,” the second CPU makes a determination of “No” in Step 905, proceeds to Step 995, and temporarily finishes this routine.

Meanwhile, when the value of the start flag Xstart is “1,” the second CPU executes processing in Step 910 to Step 920 in this order.

Step 910: The second CPU acquires the image data from the cameras 31.

Step 915: The second CPU generates the plane image based on the image data, and transmits, to the portable terminal 27, image data (latest plane image data) relating to the generated plane image.

Step 920: The second CPU determines whether or not the operation signal has been received from the portable terminal 27 in a period from a time when this routine has been previously executed to the current time.

When the second CPU has received the operation signal from the portable terminal 27 in the above-mentioned period, the second CPU makes a determination of “Yes” in Step 920, and proceeds to Step 925. In Step 925, the second CPU determines whether or not the value of a deceleration flag Xdec is “0.” The value of the deceleration flag Xdec is set to “1” when the vehicle VA arrives at the deceleration start position (see Step 1020 of FIG. 10). The value thereof is set to “0” when the vehicle VA arrives at the target stop position (see Step 1030 of FIG. 10). The value of the deceleration flag Xdec is set to “0” also by the initial routine. The deceleration start position is the position before the target stop position by a predetermined deceleration distance along the target path. A detailed description is below given of the deceleration start position.

When the value of the deceleration flag Xdec is “0,” the second CPU makes a determination of “Yes” in Step 925, proceeds to Step 930, and executes travel control such that the vehicle VA travels along the target path at a target speed Vst set in advance. After that, the second CPU proceeds to Step 995, and temporarily finishes this routine.

A specific description is now given of the travel control. The second CPU acquires a vehicle speed Vs indicating a current speed of the vehicle VA from a vehicle speed sensor (not shown), and calculates a target acceleration Gt for causing the vehicle speed Vs to match the predetermined target speed Vst. After that, the second CPU transmits the target acceleration Gt to the drive ECU 40 and the brake ECU 50. The drive ECU 40 controls the drive source actuator 42 so that an acceleration G of the vehicle VA matches the received target acceleration Gt. The brake ECU 50 controls the brake actuator 52 so that the acceleration G of the vehicle VA matches the received target acceleration Gt. The acceleration of the vehicle VA is obtained by differentiating the vehicle speed Vs with respect to time. Further, the second CPU calculates a target steering angle for the vehicle VA to travel along the target path, and transmits the target steering angle to the steering ECU 60. The steering ECU 60 controls the steering motor 63 so that the steering angle 9s matches the target steering angle.

Meanwhile, when the second CPU proceeds to Step 925, and the value of the deceleration flag Xdec is “1,” the second CPU makes a determination of “No” in Step 925, proceeds to Step 935, and executes a deceleration-for-stop control of stopping the vehicle VA at the target stop position. After that, the second CPU proceeds to Step 995, and temporarily finishes this routine.

A specific description is now given of the deceleration-for-stop control. The second CPU transmits an acceleration for stop Gst (<0) set in advance to the drive ECU 40 and the brake ECU 50. The acceleration for stop Gst is a negative value, and is a deceleration. The drive ECU 40 controls, based on the received acceleration for stop Gst, the drive source actuator 42 so that the drive source 42a does not generate the driving force. The brake ECU 50 controls the brake actuator 52 so that the acceleration G of the vehicle VA matches the acceleration for stop Gst. Also in the deceleration-for-stop control, the second CPU transmits, to the steering ECU 60, the target steering angle for the vehicle VA to travel along the target path.

Meanwhile, when the second CPU proceeds to Step 920, and has not received the operation signal from the portable terminal 27, the second CPU makes a determination of “No” in Step 920, and proceeds to Step 940. In Step 940, the second CPU executes no-operation deceleration control of decelerating the vehicle VA at a no-operation acceleration Gnt (<0) set in advance. The no-operation acceleration Gnt is a negative value, and is a deceleration. After that, the second CPU proceeds to Step 995, and temporarily finishes this routine.

For example, the no-operation acceleration Gnt is set to a value smaller than the acceleration for stop Gst. The no-operation deceleration control is different from the deceleration-for-stop control in such a point that the no-operation acceleration Gnt is transmitted in place of the acceleration for stop Gst, and is the same as the deceleration-for-stop control in the other points, and a detailed description is thus not given.

<Arrival Determination Routine>

The second CPU executes an arrival determination routine of FIG. 10 illustrated as a flowchart each time a predetermined period elapses. The second CPU executes this routine in the ignition-on state.

Thus, the second CPU starts processing from Step 1000 at a predetermined timing, proceeds to Step 1005, and determines whether or not the value of the start flag Xstart is “1.” When the value of the start flag Xstart is “0,” the second CPU makes a determination of “No” in Step 1005, proceeds to Step 1095, and temporarily finishes this routine.

Meanwhile, when the value of the start flag Xstart is “1,” the second CPU makes a determination of “Yes” in Step 1005, proceeds to Step 1010, and determines whether or not the value of the deceleration flag Xdec is “0.”

When the value of the deceleration flag Xdec is “0,” the second CPU makes a determination of “Yes” in Step 1010, and executes processing in Step 1013 and Step 1015 in this order.

Step 1013: The second CPU acquires the vehicle speed Vs at the current time, calculates a deceleration distance required to stop the vehicle VA at the target stop position based on the vehicle speed Vs and the acceleration for stop Gst, and identifies, as the deceleration start position, the position before the target stop position by the deceleration distance along the target path. As described above, the vehicle speed Vs in the travel control is highly likely the target vehicle speed Vst. However, in a case in which operation invalid deceleration control is executed or the like, there is a fear in that the vehicle speed Vs does not match the target vehicle speed Vst. Thus, the second CPU acquires the vehicle speed Vs each time a predetermined period elapses, to thereby identify the deceleration start position.

Step 1015: The second CPU determines whether or not the vehicle VA has arrived at the deceleration start position.

The second CPU identifies the current position of the vehicle VA on the target path based on the vehicle speed Vs and the steering angle θs, and determines that the vehicle VA has arrived at the deceleration start position when the identified current position matches the deceleration start position.

When the vehicle VA has not arrived at the deceleration start position, the second CPU makes a determination of “No” in Step 1015, proceeds to Step 1095, and temporarily finishes this routine.

Meanwhile, when the vehicle VA has arrived at the deceleration start position, the second CPU makes a determination of “Yes” in Step 1015, proceeds to Step 1020, and sets the value of the deceleration flag Xdec to “1.” After that, the second CPU proceeds to Step 1095, and temporarily finishes this routine.

When the second CPU proceeds to Step 1010, and the value of the deceleration flag Xdec is “1,” the second CPU makes a determination of “No” in Step 1010, and proceeds to Step 1025. In Step 1025, the second CPU determines whether or not the vehicle VA has arrived at the target stop position. In more detail, when the current position of the vehicle VA on the target path identified based on the vehicle speed Vs and the steering angle θs matches the target stop position, the second CPU determines that the vehicle VA has arrived at the target stop position.

When the vehicle VA has not arrived at the target stop position, the second CPU makes a determination of “No” in Step 1025, proceeds to Step 1095, and temporarily finishes this routine.

When the vehicle VA has arrived at the target stop position, the second CPU makes a determination of “Yes” in Step 1025, and executes processing in Step 1030 to Step 1045 in this order.

Step 1030: The second CPU sets the value of the start flag Xstart to “0,” and sets the value of the deceleration flag Xdec to “0.”

Step 1035: The second CPU transmits the end signal to the portable terminal 27.

Step 1040: The second CPU does not cause the drive source 42a to transition to the non-actuation state, but continues to maintain the drive source 42a in the actuation state.

Step 1043: The second CPU actuates a parking brake actuator (not shown), to thereby change a shift position to a parking position.

When the parking brake actuator is actuated, a friction braking force is applied to the wheels, and the stop state of the vehicle VA is thus maintained.

Step 1045: The second CPU sets the value of the invalidity flag Xinv to “1.” After that, the second CPU proceeds to Step 1095, and temporarily finishes this routine.

<Drive Control Routine>

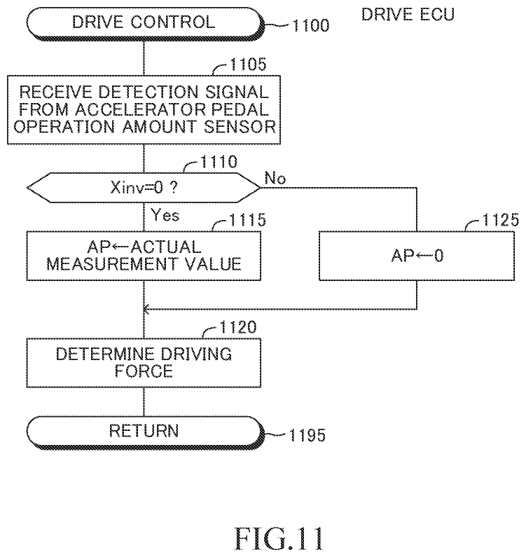

The CPU of the drive ECU 40 (“third CPU” hereinafter refers to the CPU of the drive ECU 40 unless otherwise specified) executes a drive control routine illustrated in a flowchart of FIG. 11 each time a predetermined period elapses. The drive ECU 40 is not activated in the ignition-off state, and is activated in the ignition-on state. Thus, the third CPU thus executes this routine in the ignition-on state.

Thus, the third CPU starts processing from Step 1100 at a predetermined timing, and executes processing in Step 1105 and Step 1110 in this order.

Step 1105: The third CPU acquires the detection signal from the accelerator pedal operation amount sensor 41.

Step 1110: The third CPU determines whether or not the value of the invalidity flag Xinv is “0.” The parking ECU 30 notifies the drive ECU 40 of the value of the invalidity flag Xinv each time a predetermined period elapses.

When the value of the invalidity flag Xinv is “0,” the third CPU makes a determination of “Yes” in Step 1110, and executes processing in Step 1115 and Step 1120 in this order.

Step 1115: The third CPU sets the accelerator pedal operation amount AP to the accelerator pedal operation amount AP (actual measurement value of the accelerator pedal operation amount sensor 41) indicated by the detection signal received in Step 1105.

Step 1120: The third CPU determines the driving force based on the accelerator pedal operation amount AP set in Step 1115 or Step 1125 described below, and controls the drive source actuator 42 so that the drive source 42a generates the driving force.

When the drive ECU 40 has received, from the parking ECU 30, an acceleration (hereinafter referred to as “control acceleration”) of any one of the target acceleration Gt, the acceleration for stop Gst, and the no-operation acceleration Gnt, the third CPU controls the drive source actuator 42 so that the drive source 42a generates a larger driving force of the driving force determined based on the accelerator pedal operation amount AP and the driving force determined based on the control acceleration.

After that, the third CPU proceeds to Step 1195, and temporarily finishes this routine.

Meanwhile, when the third CPU proceeds to Step 1110, and the value of the invalidity flag Xinv is “1,” the third CPU makes a determination of “No” in Step 1110, proceeds to Step 1125.

In Step 1125, the third CPU sets the accelerator pedal operation amount AP to “0,” proceeds to Step 1120, and determines the driving force. After that, the third CPU proceeds to Step 1195, and temporarily finishes this routine.

When the value of the invalidity flag Xinv is “1,” the accelerator pedal operation amount AP is set to “0” regardless of the actual measurement value of the accelerator pedal operation amount sensor 41. In other words, when the value of the invalidity flag Xinv is “1,” the accelerator pedal operation amount AP is set to “0” regardless of the operation on the accelerator pedal 41a. Thus, the drive source 42a does not generate the driving force.

As appreciated from the description given above, with the present control device 10, the consumed electric power of the DCU 25 can be reduced, and the DCU 25 can be activated without requiring the operation of the user when there is a high possibility that the communication with the portable terminal 27 is to be required.

The present disclosure is not limited to these embodiments and modified examples, and can adopt various modified examples within the scope of the present disclosure.

### First Modification Example

The activation condition is only required to be a condition that is satisfied when the legitimate user exists within the range which is outside the vehicle and in which the distance from the vehicle VA is shorter than the predetermined distance, and is not limited to the above-mentioned example. For example, the function of the electronic key 26 may be implemented in the portable terminal 27, and when the portable terminal 27 receives the request signal, the portable terminal 27 transmits the response signal including the key ID assigned in advance to the portable terminal 27. When the vehicle-outside reception antenna 22 receives the response signal from the portable terminal 27, and the key matching is successful, it may be determined that the activation condition is satisfied. In this example, the vehicle control system may not include the electronic key 26.

### Second Modification Example

The cancellation condition is only required to be a condition that there can be confirmed, without requiring an operation by a user holding the legitimate qualification, the state in which the user has gotten in the vehicle VA, and is not limited to the above-mentioned example. Description is now given of examples of the cancellation condition.

The matching ECU 20 receives, after the start operation for the remote operation control has been executed, from the portable terminal 27, position information indicating the current position of the portable terminal 27 on which the start operation has been executed. When the matching ECU determines, based on the position information, that the current position of the portable terminal 27 is inside the vehicle after the vehicle VA has arrived at the target stop position, the matching ECU may determine that the cancellation condition is satisfied.

Further, a driver's seat camera configured to capture the face of a person sits in the driver's seat, to thereby generate face image data is provided in the vehicle VA. The matching ECU 20 acquires the face image data generated by the driver's seat camera after the vehicle VA arrives at the target stop position, and compares the acquired face image data and face image data on the legitimate user stored in advance with each other. After that, when the matching ECU 20 determines that the user who sits in the driver's seat after the vehicle VA has arrived at the target stop position is the legitimate user based on both of the pieces of face image data, the matching ECU 20 may determine that the cancellation condition is satisfied.

### Third Modification Example

The parking ECU 30 notifies the brake ECU 50 of the value of the invalidity flag Xinv each time the predetermined period elapses. When the value of the invalidity flag Xinv is “1,” the brake ECU 50 may invalidate the operation on the brake pedal 51a, and the steering ECU 60 may invalidate the operation on the steering wheel 61a.

In more detail, when the value of the invalidity flag Xinv is “1,” the brake ECU 50 sets the brake pedal operation amount BP to “0” regardless of the actual measurement value of the brake pedal operation amount sensor 51. Further, when the value of the invalidity flag Xinv is “1,” the steering ECU 60 sets the steering torque Tr to “0” regardless of the actual measurement value of the steering torque sensor 62.

### Fourth Modification Example

In Step 720 of FIG. 7, the second CPU may determine the target stop position such that the front-and-rear direction upon stopping matches a current front-and-rear direction. In this case, the second CPU determines, as the target path, such a path that the vehicle VA travels straight. The target stop position and the target path may be determined by the operator of the portable terminal 27.

What is claimed is:

1. A vehicle control system, comprising:
a portable terminal configured to execute wireless communication; and
a vehicle which includes a communication device configured to establish a wireless communication connection with the portable terminal to be enabled to wirelessly communicate with the portable terminal when the communication device is in an activated state, and to be disabled to wirelessly communicate with the portable terminal when the communication device is in an inactivated state, the vehicle being configured to automatically travel to a predetermined target position in accordance with an instruction received by the communication device through the wireless communication with the portable terminal,
wherein the portable terminal is configured to transmit the instruction when a predetermined operation is executed by a user, and
wherein the vehicle is configured to monitor, when the communication device is in the inactivated state, whether an activation condition is satisfied, the activation condition being satisfied when a user holding legitimate qualification for driving the vehicle exists within a predetermined communication possible range, which is outside the vehicle, and in which a distance from the vehicle is shorter than a predetermined distance, and to change a state of the communication device from the inactivated state to the activated state when the activation condition is satisfied.

2. The vehicle control system according to claim 1, further comprising an electronic key configured to transmit an electronic key wireless signal including a key identifier assigned in advance,
wherein the vehicle is configured to:
receive the electronic key wireless signal when the electronic key exists within the communication possible range even when the communication device is in the inactivated state;
determine, when the communication device is in the inactivated state and the electronic key wireless signal is received, whether the key identifier included in the electronic key wireless signal matches a vehicle unique identifier stored in advance; and
determine that the activation condition is satisfied when the key identifier and the vehicle unique identifier are determined to match each other.

3. The vehicle control system according to claim 1,
wherein the vehicle further includes a drive device configured to apply a driving force to the vehicle when the drive device is in an actuation state, and to avoid applying the driving force to the vehicle when the drive device is in a non-actuation state,
wherein the portable terminal includes a display of a touch panel type,
wherein the portable terminal is configured to:
display, on the display, a start screen including a predetermined startup operation region when the wireless communication connection with the communication device is established; and
transmit a startup signal to the communication device when the user executes a predetermined startup operation in the predetermined startup operation region, and
wherein, when the communication device receives the startup signal under a state in which the drive device is in the non-actuation state, the vehicle is configured to start up the drive device, to thereby change a state of the drive device to the actuation state.

4. The vehicle control system according to claim 3,
wherein the portable terminal is configured to:
display, on the display, a confirmation screen, which includes a predetermined confirmation operation region, and allows the user to confirm the predetermined target position, after the user executes the predetermined startup operation; and
transmit a confirmation signal to the communication device when the user executes a predetermined confirmation operation in the confirmation operation region, and
wherein the vehicle is configured to start control of causing the vehicle to travel toward the predetermined target position when the vehicle receives the confirmation signal.

5. The vehicle control system according to claim 1,
wherein the vehicle further includes a drive device configured to apply a driving force to the vehicle when the drive device is in an actuation state, and to avoid applying the driving force to the vehicle when the drive device is in a non-actuation state, and
wherein the vehicle is configured to:
control the drive device so that the driving force is changed based on an operation by the user of an accelerator provided inside the vehicle, when the drive device is in the actuation state;
maintain the drive device in the actuation state without changing the drive device to the non-actuation state after an arrival time being a time at which the vehicle arrives at the predetermined target position; and
invalidate the operation of the accelerator such that the driving device does not apply the driving force to the vehicle even when the accelerator is operated, in a period from the arrival time to a cancellation condition satisfaction time at which a cancellation condition is satisfied, the cancellation condition allowing confirmation that the user holding legitimate qualification has gotten in the vehicle without requiring an operation of the user.

6. A vehicle, comprising:
a communication device, which is mounted to the vehicle, and is configured to establish a wireless communication connection with a portable terminal to be disabled to wirelessly communicate with the portable terminal when the communication device is in an activated state, and to be disabled to wirelessly communicate with the portable terminal when the communication device is in an inactivated state; and
a travel control device configured to cause the vehicle to travel such that the vehicle automatically travels to a predetermined target position in accordance with an instruction received by the communication device through the wireless communication with the portable terminal,
wherein the travel control device is configured to monitor, when the communication device is in the inactivated state, whether an activation condition is satisfied, the activation condition being satisfied when a user holding legitimate qualification for driving the vehicle exists within a predetermined communication possible range, which is outside the vehicle and in which a distance from the vehicle is shorter than a predetermined distance, and to change a state of the communication device from the inactivated state to the activated state when the activation condition is satisfied.
